(19) United States
(12) Patent Application Publication
(10) Pub. No.: US 2025/0367629 A1
(43) Pub. Date: Dec. 4, 2025

(54) BAFFLE PLATE AND METHODS OF INSTALLING BAFFLE PLATE IN A CATALYST INLET REGION OF A CATALYST COOLER WITH SIDE INLET

(71) Applicant: PETRÓLEO BRASILEIRO S.A. – PETROBRAS, Rio de Janeiro (BR)

(72) Inventors: Emanuel Freire SANDES, Rio de Janeiro (BR); Nelson PATRICIO JUNIOR, Rio de Janeiro (BR); Guintar Luciano BAUGIS, Maua (BR); Raphael COELHO SCHIAVO, Rio de Janeiro (BR); Paulo Sergio FREIRE, Rio de Janeiro (BR)

(21) Appl. No.: 19/196,038

(22) Filed: May 1, 2025

(30) Foreign Application Priority Data
May 28, 2024 (BR) 1020240106318

(51) Int. Cl. B01J 8/34

(52) U.S. Cl. CPC B01J 8/34; B01J 2208/00221

(57) ABSTRACT

The present disclosure discloses a baffle plate, and associated methods, installed in a catalyst inlet region of a catalyst cooler with side inlet, wherein the baffle plate is fixed in front of the first row of tubes of a bundle closest to the catalyst inlet region of the catalyst cooler, positioned so as to deflect gases entrained by the catalyst flow that enter a shell of the catalyst cooler through the upper section of the inlet nozzle.

### FIELD OF THE DISCLOSURE

The present disclosure falls within the technical field of fluid catalytic cracking (FCC) technologies. More specifically, the present disclosure relates to increasing the campaign time and reliability of catalyst coolers in residue fluid catalytic cracking (RFCC) units.

### BACKGROUND OF THE DISCLOSURE

The processing of residue feeds in RFCC units results in a very high coke production. While fluid catalytic cracking (FCC) units have a coke yield of 4 to 6% w/w, RFCC units can achieve values as high as 8 to 12% w/w.

The greater amount of coke in RFCC units results in a high energy release in the regenerator, far above the energy demand of the converter. To deal with this excess energy, so-called “catalyst coolers” are installed in RFCCs, equipment designed to cool the bed. Without them, processing loads with a higher residue content would be unfeasible.

Catalyst coolers remove heat from the hot catalyst bed through a bundle of water. They are similar to a heat exchanger. The natural or forced circulation of water, which passes through the bundle, removes excess heat from the catalyst, which is returned to the regenerator at a lower temperature. The energy absorbed by the water results in the generation of high-pressure saturated steam, which is used by the RFCC unit itself and/or by other units in the refinery. The amount of heat that is removed by the catalyst cooler is controlled by a valve at its outlet, which regulates the circulation of catalyst and consequently the thermal load of the equipment.

Because the FCC catalyst is extremely abrasive, erosion of the bundle and the consequent appearance of holes in the tubes has always been a concern for designers of this type of equipment. FIGS. 1, 2 and 3 illustrate a typical schematic of a catalyst cooler from different designers KBR, UOP and Stone & Webster, respectively.

The KBR design, as illustrated in FIG. 1, was designed with a single bundle, aiming at a simpler and lower cost alternative. The disadvantage of this design is that if a tube punctures, the catalyst cooler is completely lost. KBR tries to solve this problem by applying a hard coating to the first and second rows of tubes, which are normally the most subject to erosion, due to their proximity to the catalyst inlet in the shell. Although the application of the high erosion resistance coating increases the life of the tubes, industrial practice shows that the durability of these coatings is limited, and that depending on the operating conditions of the catalyst coolers, the coatings can end up failing after 36 to 48 months of campaign.

The UOP design was conceived in order to try to avoid the aforementioned problem, with the catalyst entering through the upper part of the equipment, as illustrated in FIG. 2. Unlike the KBR and Stone & Webster models, in the UOP model there is no transverse incidence of the catalyst flow over the bundle.

Stone & Webster attempts to solve the erosion problem by inserting multiple bundle assemblies, which allow for independent isolation, as illustrated in FIG. 3. Thus, if a hole is identified in one of the tubes, the RFCC unit does not need to stop, simply blocking the water inlet to the assembly where the holed tube is located and continuing to operate. Since the thermal load of the catalyst cooler will be reduced, the refiner will need to reduce the RFCC feed flow or adjust the feed quality by processing a lighter residue. Although this is not ideal, such an arrangement allows the refiner to gain some time to plan the shutdown and repair of the bundle. This flexibility, however, comes at a price: a more complex and more expensive arrangement. It is a palliative solution to the problem, also accompanied by loss of financial revenue, and which should only be resolved after the unit has been shut down and the bundle has been repaired.

The erosion problem is of particular importance for catalyst coolers in which the catalyst enters the cooler through the side of the shell. Although the arrangement has a number of benefits, it has resulted in a critical erosion problem in the first rows of tubes near the catalyst inlet. The strong erosion in the tubes of the first and second rows results in unscheduled shutdowns of RFCCs due to holes in the catalyst cooler bundles, leading to significant loss of revenue. The lack of reliability in this equipment is an impediment to carrying out longer campaigns, which would be desirable to increase profitability.

Therefore, in view of the various solutions tested over the last decades, a new means of reducing erosion of tubes in catalyst cooler bundles of residue fluid catalytic cracking (RFCC) units is needed, in order to solve the erosion problem and thus increase the campaign time of the catalyst coolers.

### STATE OF THE ART

In the state of the art there are some documents that address the distribution of particles and erosion phenomena in catalyst coolers of fluid catalytic cracking units.

The main objective of the document “Investigation on distribution of particles in inlet region of an FCC external catalyst cooler with different inlet structures” is to optimize heat exchange in catalyst coolers, an aspect compromised, according to them, by the poor distribution of catalyst particles that enter the cooler.

The Authors emphasize that the poor distribution of hot particles that enter the shell causes the appearance of temperature differentials on the metal surface of the bundle tubes, and thus the appearance of localized stresses in the tubes, which can result in cracks and/or fractures in the tubes, which can lead to leakage of cooling water. Additionally, the poor distribution of catalyst particles can also result in the formation of “dead zones” inside the cooler, regions with a low degree of fluidization.

To solve this problem, the Authors propose introducing flow divider plates at the cooler inlet, capable of simultaneously reducing the speed and dividing the flow. Two different structures are tested, one that divides the flow into two parts and another that divides the flow into three parts, both with the aim of obtaining a more uniform distribution of the catalyst particles in the radial section of the cooler.

Said document may even reduce tube failures by reducing the thermal differential, but it would not reduce the erosion problem and could even intensify it by directing the catalyst flow in a certain direction. Failure due to erosion is different from failure due to thermal differential. While erosion is caused by the impingement of catalyst particles on the bundle or by gas cavitation at the top of the bed, high stress cracks are caused by thermal differential in the tubes.

Additionally, said document provides the understanding that the gas segregated in the feed tube of the cooler inlet tube has an upward direction, and therefore could not contribute to the erosion process observed in the catalyst cooler bundles.

The document “State-of-the-Art Review of Fluid Catalytic Cracking (FCC) Catalyst Regeneration Intensification Technologies” shows a review of the state of the art regarding aspects applied in the design of FCC regenerators.

The document shows the use of baffles and other internals that are inserted in the bed of regenerators that operate at low speed, with the purpose of 1) improving the radial distribution of the catalyst in the bed, 2) preventing large diameter bubbles from being formed, 3) minimizing catalyst drag at the top of the bed, 4) minimizing gas bypass towards the center of the vessel, and 5) promoting efficient heat exchange of the energy dissipated by the burning of coke in the catalyst inventory.

However, the use of baffles in the bed to reduce bubble energy and the description of erosion caused by catalyst recirculation induced by high-speed jets in air distributor nozzles of FCC regenerators, combined, do not shed light on the erosion problem observed in catalyst cooler bundles. The document only briefly mentions the problem; however, as it is a technological review, it does not propose a new solution.

The document U.S. Pat. No. 9,587,824 B2 discloses a catalyst cooler for cooling regenerated catalyst in a regenerator associated with a fluid catalytic cracking unit. The catalyst cooler includes a first passage for transporting hot regenerated catalyst away from the regenerator, and a second passage for returning cooled regenerated catalyst to the regenerator. The catalyst cooler also includes at least one heat exchanger. The second passage may be disposed within the first passage, or the first and second passages may each occupy a portion of a horizontal cross-section of the catalyst cooler.

It is noted that the document U.S. Pat. No. 9,587,824 B2 represents an improvement introduced by designer UOP in its catalyst cooler design. However, it is noteworthy that since this configuration is not a side entry configuration, it has no similarities with the present disclosure.

The document CN 113041963 discloses a pre-lift catalyst distribution plate structure, which comprises a riser tube, wherein the lower part of the riser tube is a lower cylinder of the riser tube, a pre-lift section cylinder, a vapor extraction steam ring tube, and a vapor extraction steam nozzle, arranged in the riser tube. The vapor extraction steam ring tube and the vapor extraction steam nozzle are positioned below the cylinder of the pre-lift section; a spiral distribution plate is arranged in the cylinder of the pre-lift section, a wear-resistant lining used to reduce abrasion wear of a catalyst for the spiral distribution plate is placed on the upper part of the spiral distribution plate, and the catalyst overflow holes of the distribution plate are evenly distributed in a staggered manner.

It is noted that document CN 113041963 relates to a mixer of two streams of cold and hot catalyst, which are sent to the reaction section through a riser. Therefore, this document has no relation to the present disclosure.

In view of the disclosure of the prior art, the features and advantages of the present disclosure will clearly emerge from the detailed description below and with reference to the attached drawings.

### BRIEF DESCRIPTION OF THE DISCLOSURE

The present disclosure discloses embodiments of a baffle plate (100), and associated methods, installed in a catalyst inlet region of a catalyst cooler (200) with side inlet, wherein the baffle plate (100) is fixed in front of the first row of tubes of a bundle (220) closest to the catalyst inlet region of the catalyst cooler (200); positioned to deflect the gases entrained by the catalyst flow that enter a catalyst cooler shell (200) through the upper section of the inlet nozzle (210).

### BRIEF DESCRIPTION OF THE FIGURES

In order to complement this description and obtain a better understanding of the features of the present disclosure, a set of figures is shown, where in an exemplary, non-limiting manner, preferred embodiments are represented.

FIG. 1 illustrates a typical diagram of a catalyst cooler from a corporate designer according to the prior art.

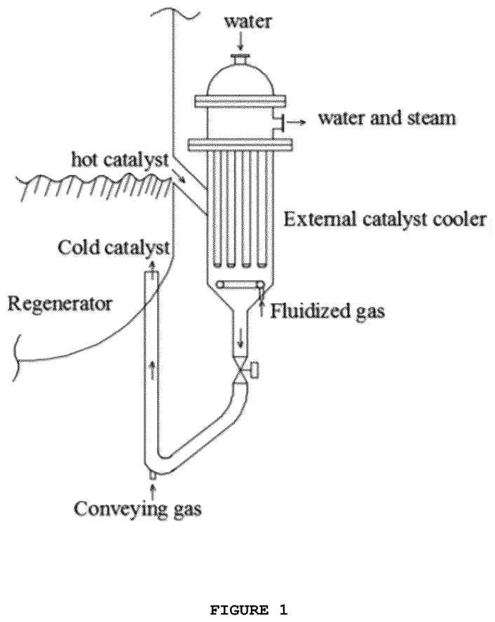

FIG. 2 illustrates a typical diagram of a catalyst cooler from another corporate designer according to the prior art.

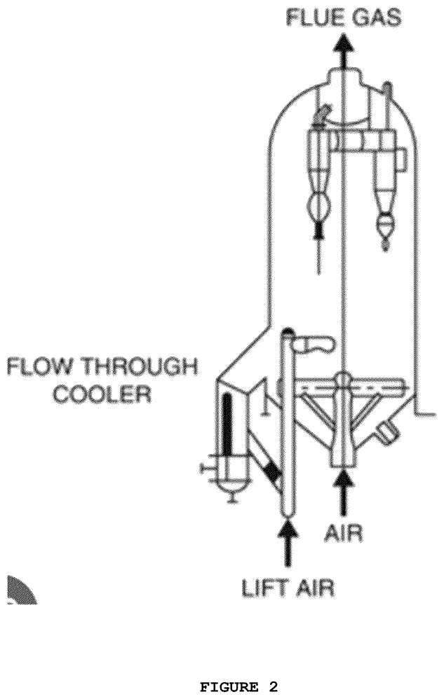

FIG. 3 illustrates a typical diagram of a catalyst cooler from yet another corporate designer according to the prior art.

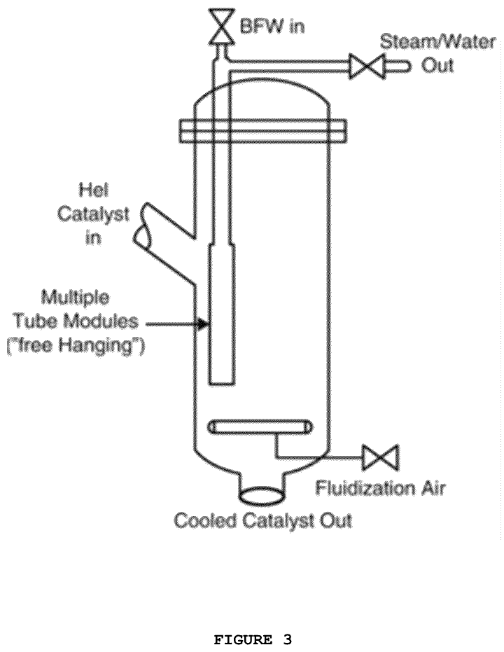

FIG. 4 illustrates an erosion area of a coating area of rows of tubes close to a catalyst inlet, highlighting a critical erosion region observed in the first and second rows of tubes of a bundle (220) according to the present disclosure.

FIG. 5 illustrates cavitation marks on one of the tubes in the first row according to the present disclosure.

FIG. 6 illustrates, by way of example, the entrainment of gases from a regenerator to the interior of the shell of a catalyst cooler (200) without the baffle plate of the present disclosure.

FIG. 7 illustrates, by way of example, the entrainment of gases from a regenerator to the interior of the shell of a catalyst cooler (200) with the baffle plate (100) of an embodiment of the present disclosure.

FIG. 8 illustrates a top view in section, revealing details of the installation of the baffle plate in a catalyst cooler according to an embodiment of the present disclosure.

FIG. 9 illustrates a section view of a catalyst inlet nozzle (210) of a catalyst cooler (200), exemplifying the region of diversion and collection of gases in the upper passage of the inlet nozzle as a result of the positioning of a baffle plate (100) according to an embodiment of the present disclosure.

FIG. 10 illustrates an exemplary attachment of the baffle plate (100) to a first row of tubes of a bundle (220), closest to a catalyst inlet region of the catalyst cooler according to an embodiment of the disclosure.

FIG. 11 illustrates the installation of a prototype baffle plate in a catalyst cooler of an RFCC unit of the proponent according to an embodiment of the disclosure.

FIG. 12 illustrates photographs of the final state of a tube of the first row of a catalyst cooler that operated in the traditional configuration without a plate (on the left) compared to the final state of tubes of the first row of a catalyst cooler that operated with a plate (on the right) according to an embodiment of the present disclosure.

FIG. 13 illustrates a graph of the thermal load of the catalyst cooler before and after the installation of the baffle plate according to an embodiment of the present disclosure.

### DETAILED DESCRIPTION OF THE DISCLOSURE

The present disclosure relates to a baffle plate (100) installed in a catalyst inlet region of a catalyst cooler (200) with side inlet.

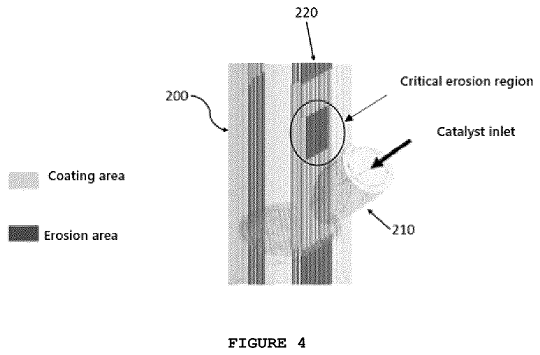

The baffle plate (100) aims to prevent erosion of rows of tubes of a bundle (220) close to a catalyst inlet. More particularly, as illustrated in FIG. 4, to prevent erosion of a critical region in the first and second rows of tubes of a bundle (220) closest to a catalyst inlet nozzle (210) in the shell of the catalyst cooler (200).

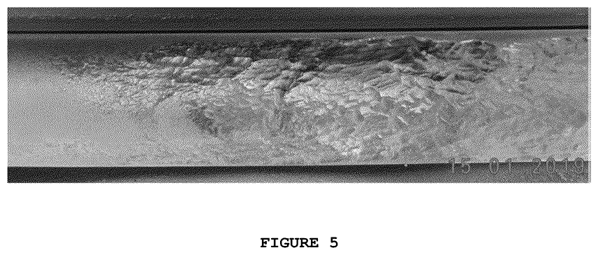

The critical erosion region coincides with a top region (241) of a catalyst bed (240) inside the catalyst cooler (200). As illustrated in FIG. 5, the marks on the metal surface of a tube in the first row of the bundle (220) in said area indicate a cavitation process, caused by the eruption and rupture of gas bubbles at the top of the bed.

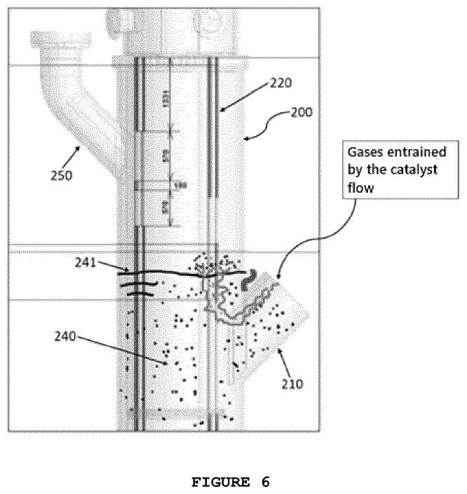

The fact that erosion is only observed in the rows close to the catalyst inlet nozzle (210) in the shell also indicates that the gas flow that is causing this phenomenon does not originate from the fluidization air injected below the bundle (220), but rather from the gases coming from the regenerator, which are dragged to the catalyst cooler (200) by the catalyst flow itself coming from the catalyst inlet nozzle (210), as illustrated in FIG. 6.

The drag phenomenon is well known in the literature on FCC unit standpipes and can reach values as high as 1 to 1.5 kg/ton of circulating catalyst. Depending on the operating conditions of the catalyst cooler, the drag of gases by the catalyst flow can reach flow rates of 50% to 75% of the fluidization air flow injected into the bottom of the shell. The problem is that, instead of being distributed throughout the cross-sectional area, it is concentrated at a single point: at the inlet (210) of the shell, next to the first and second rows of tubes of a bundle (220).

Therefore, the present disclosure identifies that it is necessary to prevent the gas stream dragged from the regenerator to the catalyst cooler (200) from entering the region of the bundles, thus eliminating the “explosion” of bubbles at the top of the bed (241) that cause the cavitation process on the walls of the tubes of a bundle (220), especially in the first and second rows close to the inlet nozzle (210).

To this end, an innovative concept is proposed capable of capturing part of the segregated gas and directing it to a confined region by means of the baffle plate (100), where the eruption of the gas in the bed (240) will not result in the cavitation process near the surface of the tubes of a bundle (220) of the catalyst cooler (200).

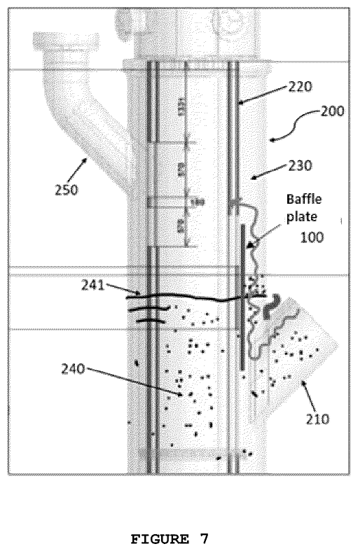

More particularly, the installation of the baffle plate (100) is capable of capturing most of the gases flowing in the upper generator of the inlet nozzle (210) of the catalyst cooler (200), moving the gas stream away from the highest temperature area of the bundle (220) and distributing it, predominantly, in the diluted phase (230) of the shell, in a region in which the walls of the tubes are at a lower temperature, and consequently with greater resistance to erosion. Thus, the installation of the baffle plate allows the explosion of the bubbles at the top of the bed (241) to occur in an area separate from the region of the bundle tubes (220), wherein the explosion of the bubbles is contained between the baffle plate (100) and the shell of the catalyst cooler (200), thus eliminating the phenomenon of cavitation on the surface of the bundles (220), as illustrated in FIG. 7.

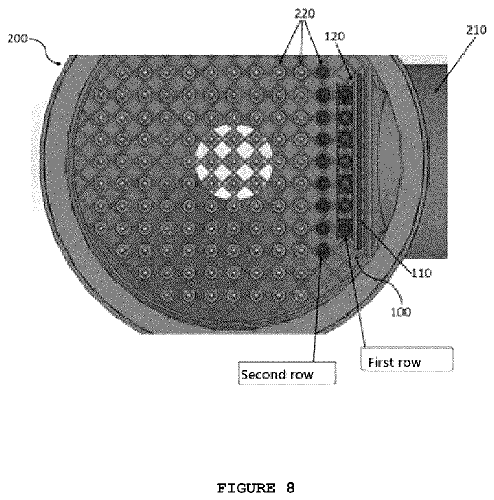

Preferably, the face of the baffle plate (100) facing the gas eruption at the top of the bed (241) is protected with layers of at least 1 inch (25.4 mm) of anti-erosion refractory (110), preferably class “A” anchored in hexagonal mesh, as illustrated in FIG. 8.

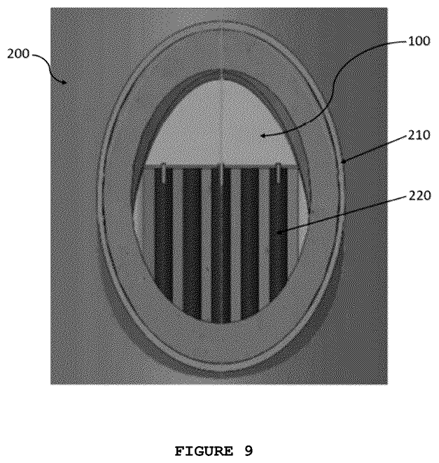

The baffle plate (100) is positioned so that the reduction in the passage area of the catalyst inlet nozzle (210) preferably does not exceed 30%, as illustrated in greater detail in FIG. 9. Its insertion into the inlet nozzle may be 20% to 40% of the total height of the ellipse formed by the nozzle next to the catalyst cooler shell (200), sufficient to provide effective collection of the gases flowing in the upper section of the inlet nozzle (210).

Additionally, the baffle plate (100) may comprise a total height sufficient for the relief of the gases collected in the inlet nozzle (210) to occur in the diluted phase (230) of the catalyst cooler, at a point sufficiently distant from the top (241) of a catalyst bed (240) and preferably below the elevation of the vent (250).

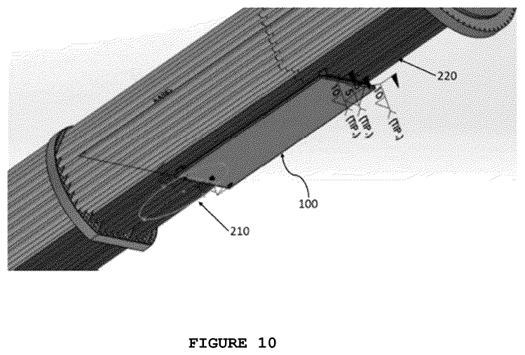

The baffle plate (100) is fixed to the first row of tubes of a bundle (220) closest to the catalyst inlet region of the catalyst cooler (200) by means of a support grid 120, supported on the tubes through the installation of stops welded directly to them, as illustrated in FIGS. 8 and 10.

It will also be appreciated that in a preferred configuration there is an open passage for the exit of gases along each of the sides of the baffle plate (100), so as to allow part of the gases to leave the confined region between the baffle plate (100) and the shell of the catalyst cooler (200) through the sides, thus reducing the upward flow of gases in this space, and consequently the drag of catalyst to the diluted phase (230).

The side passages can be designed so that each one has a passage area of 50% to 150% of the existing cross-sectional passage area between the baffle plate (100) and the catalyst cooler shell (200). This feature can have the advantage of avoiding very high velocities being observed in the gas relief regions through these outlets. The gases, once captured by the baffle plate (100), will seek to flow towards the diluted phase (230) always by the path of least resistance.

In a second configuration, the baffle plate (100) can alternatively extend to the catalyst cooler shell (200), completely eliminating the side passages (configuration not illustrated). In this configuration, the gases collected by the baffle plate (100) are sent in their entirety to the diluted phase (230), increasing the upward speed in the space confined by the plate (100). A project in such a configuration must be designed to maintain this speed within acceptable limits. The alternative configuration has the advantage of eliminating the risk of the gases exiting through the side passages resulting in new erosion points in the bundle (220) and is recommended mainly for new projects. In these cases, the baffle plate (100) can be fixed directly to the catalyst cooler shell (200), without having to fix it to the first row of tubes in a bundle (220). For revamps of existing catalyst coolers, installing the baffle plate (100) fixed to the first row of tubes and with side passages can be simpler and less expensive.

Therefore, it will be appreciated by a person skilled in the art that the baffle plate (100) of the present disclosure solves the critical erosion problem in the first rows of side-entry catalyst cooler bundles (200). The innovation may be applied to extend RFCC campaigns, bringing significant revenue gains to the refiner. Thus, the problem of punctures in campaigns, which has resulted in unscheduled unit shutdowns, with significant production losses, will have been solved.

Finally, it will be appreciated that the baffle plate (100) of the present disclosure can be applied to any catalyst cooler design that considers a catalyst inlet from the side of the shell, as is the case, for example, with the KBR and Stone & Webster designs.

### RESULTS OF THE DISCLOSURE

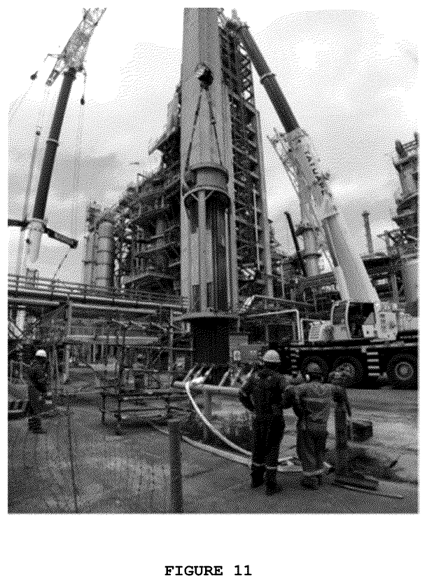

As illustrated in FIG. 11, a prototype of a baffle plate (100) was installed in one of the catalyst coolers of an RFCC unit in the field for testing. The RFCC unit is equipped with more than one catalyst cooler, and the baffle plate (100) was installed in only one equipment.

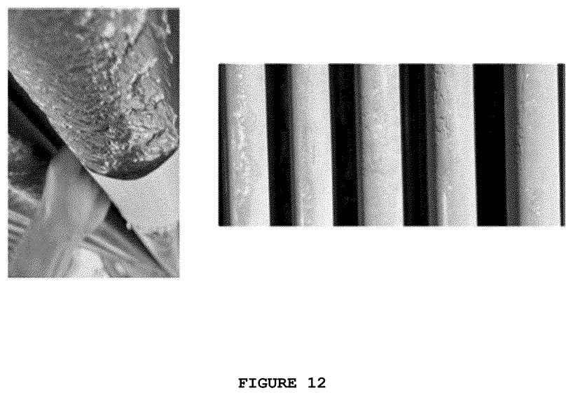

The aim of the test was to compare the erosion pattern of the beam equipped with the baffle plate (100) with the erosion observed in the traditional beam, without the plate. Both beams were subjected to the same operating conditions for comparison purposes. After 42 months of continuous operation, the RFCC was stopped for scheduled maintenance, and it was possible to inspect the catalyst cooler beams. FIG. 12 shows the final state of a tube in the first row of a catalyst cooler that operated in the traditional configuration without a plate (on the left) compared to the final state of the tubes in the first row of a catalyst cooler that operated with a plate (on the right). It can be seen that while in the traditional configuration (without a plate) the tubes suffered a severe erosion process, in the configuration with the baffle plate (100) the tubes ended the campaign practically intact. The present disclosure completely eliminated cavitation.

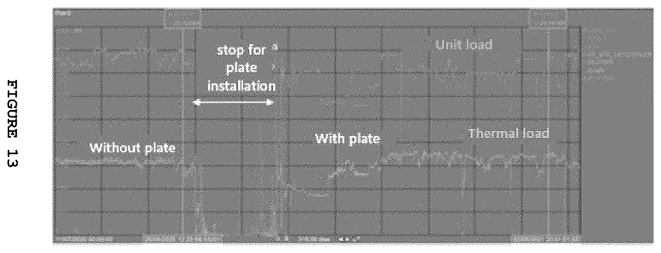

It is worth noting that the installation of the baffle plate (100) did not cause any loss of performance for the catalyst cooler that received it, and that it operated throughout the test period with performance similar to the other catalyst coolers and to its own previous history. FIG. 13 shows a graph of the thermal load of the catalyst cooler before and after the installation of the baffle plate. For the same load flow rate in the RFCC, no change was observed in the heat removal capacity of the catalyst cooler. The graph highlights two similar conditions, before and after the installation of the baffle plate, with the RFCC load at 4000 m³/d. In both cases the catalyst cooler was able to remove approximately 30 Gcal/h.

Thus, those skilled in the art will appreciate the knowledge being shown and will be able to reproduce the disclosure described in the indicated embodiment and in other variants, covered by the scope of the appended claims.

1. A baffle plate installed in a catalyst inlet region of a catalyst cooler with side inlet, the baffle plate comprising:
fixed in front of the first row of tubes of a bundle closest to the catalyst inlet region of the catalyst cooler;
positioned to deflect gases entrained by the catalyst flow that enter a shell of the catalyst cooler through the upper section of the inlet nozzle, and direct said gases to pass between the baffle plate and the shell of the catalyst cooler to the diluted phase of the shell, in a region above the top of a catalyst bed.

2. A baffle plate, according to claim 1, further comprising a total height sufficient for the relief of the gases collected in the inlet nozzle to occur in the diluted phase of the catalyst cooler, at a point sufficiently distant from the top of a catalyst bed and preferably below the elevation of the vent.

3. A baffle plate according to claim 1, further comprising the reduction of the passage area of the catalyst inlet nozzle (210) does not exceed 30%.

4. A baffle plate according to claim 1, wherein the baffle plate insertion in the inlet nozzle is 20% to 40% of the total height of the ellipse formed by the nozzle next to the shell of the catalyst cooler.

5. A baffle plate, according to claim 1, wherein the baffle plate is fixed to the first row of tubes of a bundle by means of a support grid, wherein the support grid is supported on the tubes by installing stops welded directly to them.

6. A baffle plate, according to claim 1, wherein the entrained gases comprise gas bubbles coming from a regenerator, which are dragged into the interior of the catalyst cooler shell by the catalyst flow itself.

7. A baffle plate, according to claim 1, wherein the face of the baffle plate facing the gas eruption at the top of the bed is protected with layers of at least 1 inch (25.4 mm) of anti-erosion refractory.

8. A baffle plate, according to claim 1, further comprising an open passage for the exit of gases along each side of the baffle plate, wherein the side passages are designed so that each one has a passage area of 50% to 150% of the transverse passage area existing between the baffle plate and the catalyst cooler shell.

9. The baffle plate according to claim 1, further comprising the baffle plate extending to the catalyst cooler shell.
